(19) United States
(12) Patent Application Publication
(10) Pub. No.: US 2004/0022722 A1
(43) Pub. Date: Feb. 5, 2004

(54) Zirconia in fine powder form, zirconia hydroxycarbonate and methods for preparing same

(76) Inventor: Jean-Valery Martin, Crouy-En-Thelle (FR)

Correspondence Address: Jean Louis Seugnet, Intellectual Property Department, Rhodia Inc CN 7500, 259 Prospect Plains Road, Cranbury, NJ, 08512-7500, US

(21) Appl. No.: 10/343,662

(22) PCT Filed: Jul. 9, 2001
(86) PCT No.: PCT/FR01/02200

(30) Foreign Application Priority Data
Aug. 4, 2000 (FR) 00/10331

(51) Int. Cl. C01G 25/02

(52) U.S. Cl. 423/608

(57) ABSTRACT

The present invention concerns a zirconia in the form of a fine powder, to a zirconium hydroxycarbonate and to processes for their preparation. The zirconia has a chlorine content of at most 300 ppm and a sulphur content of at most 30 ppm, and is in the form of a powder constituted either by agglomerates with an average size of at most 1.5 μm that can be disintegrated into aggregates with an average size in the range 0.1 μm to 0.6 μm, or aggregates with an average size in the range 0.1 μm to 0.6 μm. The zirconium hydoxycarbonate has the same chlorine and sulphur contents and following calcining, it results in the zirconia with the characteristics defined above. The zirconia of the invention can be used to produce condensers or oxygen probes, or it can be used in preparing catalysts.

The present invention relates to a zirconia in the form of a fine powder, to a zirconium hydroxycarbonate and to processes for their preparation.

Zirconia is a material that is used a great deal for preparing ceramic compositions with good mechanical, electrical and electronic properties. Such applications require a zirconia that is particularly pure. Known preparation processes can produce products with a high purity as regards a particular chemical element, but generally not for several elements at once. Further, fine products or readily disintegratable products are desired, to facilitate their use and increase their reactivity.

The aim of the present invention is to develop a zirconia with such characteristics.

To this end, the zirconia of the invention is characterized in that it has a chlorine content of at most 300 ppm and a sulphur content of at most 30 ppm and is in the form of a powder constituted either by agglomerates with an average size of at most 1.5 μm that can be disintegrated into aggregates with an average size in the range 0.1 μm to 0.6 μm, or by aggregates with an average size in the range 0.1 μm to 0.6 μm.

The invention also concerns a zirconium hydroxycarbonate, characterized in that it has a chlorine content of at most 300 ppm and a sulphur content of at most 30 ppm, and in that following calcining, it is capable of producing a zirconia with the characteristics defined above.

Further characteristics, details and advantages of the invention will become clear from the following description and non-limiting examples that illustrate the invention.

Firstly, the zirconia of the invention is characterized by its purity as regards chlorine and sulphur.

Throughout the description, the impurity contents are given as the weight of the element concerned with respect to the mass of zirconia. Zirconia can naturally contain up to about 2% by weight of HfO₂. The contents given are thus with respect to ZrO₂+HfO₂. Further, these amounts are determined by GDMS type analysis.

More precisely, the zirconia has a chlorine content of at most 300 ppm. More particularly, the chlorine content can be at most 100 ppm, still more particularly at most 80 ppm.

The sulphur content is at most 30 ppm, but it may be less than 10 ppm, and more particularly less than 5 ppm.

Depending on the particular implementations of the invention, the zirconia can also have a high purity with respect to other chemical elements. Thus, the titanium content can be at most 5 ppm, more particularly at most 3 ppm. Further, the sodium content can be at most 10 ppm, in particular at most 5 ppm. Further, the silicon content can be at most 300 ppm, or even at most 200 ppm.

The second characteristic of the zirconia of the invention is its fineness. It is in the form of a powder that can be constituted by agglomerates with an average size of at most 1.5 μm. In general, this size is between 0.8 μm and 1.5 μm. This size is determined by a laser granulometric technique (Coulter type). These agglomerates can be disintegrated into aggregates with an average size in the range 0.1 μm to 0.6 μm, the limits being inclusive here and throughout the description as regards the sizes. More particularly, this size can be in the range 0.2 μm to 0.5 μm. The aggregate size is determined by scanning electron microscopy (SEM) or by a laser granulometric technique (Coulter type). The term “disintegratable” as used here means that aggregates can be formed from agglomerates by breaking only the bonds between the agglomerates, leaving particles and crystallites whole. An example of grinding that can cause such disintegration is air jet grinding or ultrasound disintegration.

The aggregates can also have a tightly distributed granulometry. Thus, the dispersion index σ/m of the aggregates can be at most 1. More particularly, it is at most 0.8.

The term “dispersion index” means the ratio:

σ/m=(d₉₀−d₁₀)/2d₅₀

where:

d₉₀ is the diameter of aggregates for which 90% by volume of the aggregates have a diameter of less than d₉₀;

d₁₀ is the diameter of aggregates for which 10% by volume of the aggregates have a diameter of less than d₁₀;

d₅₀ is the mean diameter of the aggregates.

The aggregates are themselves constituted by elementary particles with an average size generally in the range 50 nm to 150 nm. The size of the elementary particles is determined by transmission electron microscopy (TEM) or by laser granulometry (Coulter type).

The elementary particles are constituted by crystallites with an average size in the range 30 nm to 65 μm. The crystallite size is determined in this instance by transmission electron microscopy (TEM) or by X ray diffraction.

In a further implementation of the invention, the zirconia can be in the form of a powder that is directly constituted by aggregates as defined above. The above description relating to the aggregates, elementary particles and crystallites is, of course, applicable to this implementation.

The zirconia of the invention has a specific surface area that is generally at most 35 m2/g, more particularly at most 25 m²/g, and in particular in the range 1 m²/g to 25 m²/g. The term “specific surface area” means the BET specific surface area determined by nitrogen adsorption, in accordance with American standard ASTM D 3663-78 established using the BRUNAUER-EMMETT-TELLER method described in “The Journal of the American Chemical Society”, 60, 309, (1938).

For the specific surface area values given above, the total pore volume of the zirconia is generally at most 1.5 ml/g, in particular in the range 0.05 ml/g to 1 ml/g. This porosity is such that at least 40% of the porosity is supplied by pores with a diameter in the range 100 to 200 nm, this pore volume and pore distribution being measured by mercury porosimetry.

The zirconia of the invention can occur in a pure monoclinic type crystalline phase.

The present invention is applicable to pure zirconia, i.e., a zirconia comprising no other elements except for the normal impurities and those mentioned above, and in a further variation is also applicable to a zirconia that comprises at least one stabilising element selected from calcium, magnesium, cerium, lanthanum, scandium and yttrium. The proportion of this stabilising element can vary, in particular with a stabilising element/ZrO₂ mole ratio in the range 1/100 to 20/100.

The invention also concerns a zirconium hydroxycarbonate, a precursor of the zirconia described above. This zirconium hydroxycarbonate is characterized by its purity, i.e., by a chlorine and sulphur content as defined above. Further, this hydroxycarbonate, when it is calcined, results in a zirconia with the characteristics that have been given above.

The hydroxycarbonate of the invention is also present in the form of a powder constituted by agglomerates with an average size of at most 2 μm, generally in the range 0.3 μm to 2 μm. This size is determined in this instance using a Sedigraph type sedimentation system. The agglomerates can be estimated to be constituted by aggregates with an average size of 1 μm.

The process for preparing zirconium hydroxycarbonate and the zirconia of the invention will now be described.

This process comprises a first step of reacting a zirconium oxychloride (ZrOCl₂) and ammonium, alkali or alkaline-earth carbonate or bicarbonate, by keeping the pH of the reaction medium constant; a step for separating the resulting precipitate; and a step for calcining this precipitate when preparing zirconia.

One characteristic of the process of the invention resides in the fact that the reaction between the oxychloride and carbonate or bicarbonate takes place at a constant or controlled pH. The term “controlled pH” means keeping the pH of the precipitation medium to a certain value, which is constant or substantially constant, by adding basic compounds or buffer solutions to the medium. The pH of the medium will vary by at most 0.5 pH units around the set value, preferably at most 0.1 pH units about that value. Examples of suitable basic compounds that can be cited are metal hydroxides (NaOH, KOH, Ca(OH)₂, . . . ) or ammonium hydroxide, or any other basic compound the constituent species of which will not form a precipitate during their addition to the reaction medium, by combination with one of the species contained in the medium, and can control the pH of the precipitation medium. A preferred basic compound of the invention is ammonia, advantageously employed in the form of an aqueous solution.

Preferably, the ammonium carbonate or bicarbonate used to prepare the products is of high purity as regards sodium.

When a zirconia containing a stabilising element is prepared, the starting reaction medium contains a salt of this stabilising element. This salt can in particular be a salt of an inorganic acid such as a nitrate. The starting product can also be a zirconium oxychloride already containing a salt or an oxide of the stabilising element.

The pH for the reaction is preferably in the range 4 to 6.

It may be advantageous to carry out the reaction semi-continuously, i.e., by simultaneously introducing the reactants into a reactor containing water prior to the start of the reaction.

The precipitation temperature is not critical but advantageously, the temperature is in the range 15° C. to 50° C. Precipitation generally takes place while stirring the reaction medium.

The precipitate obtained can be separated from the reaction medium using any suitable means, in particular by filtration. The precipitate can be washed, for example with water.

At the end of the separation step and optional precipitate washing step, the zirconium hydroxycarbonate of the invention is obtained.

The zirconia of the invention is obtained by carrying out a hydroxycarbonate calcining step.

Prior to calcining, the product can be dried at a temperature of about 100° C. for 2 to 12 hours. This drying step can produce a zirconia with a higher specific surface area. It is also possible to mature the hydroxycarbonate by taking it up again into suspension in an alkaline medium at a temperature of about 100° C. for 2 to 4 hours, for example.

The hydroxycarbonate or the dried product are calcined in air at a temperature that can be in the range 650° C. to 1200° C. The calcining temperature is determined more particularly by the specific surface area of the product to be obtained and by its loss on ignition.

After calcining, the product obtained is normally in the form of a powder constituted by particles that are agglomerates with an average size of at most 1.5 μm. However, if a finer grain size is desired, the product can be disintegrated. Disintegration under mild conditions, for example micronising type grinding (air jet grinding) is sufficient to disintegrate the above particles and to obtain the product in the form of a powder that is then constituted by aggregates with an average size in the range 0.1 μm to 0.6 μm.

The zirconia obtained can be used to produce materials with dielectric properties, such as condensers or microwave filters, or with piezoelectric properties, or in the production of ferrites, oxygen probes, fuel cells or in preparing catalysts or catalyst supports.

Examples will now be given.

In these examples, the agglomerate or aggregate size was measured using a dispersion of the product in an aqueous solution containing 0.05% by weight of sodium hexametaphosphate and which had previously undergone ultrasound probe treatment (probe with a 13 mm end piece, 20 kHz, 120 W) for 3 minutes.

### EXAMPLE 1

Reactants:

ZrOCl₂: 100 g/l;

Ammonia: 12 mol/l;

HCO₃NH₄: 1.3 mol/l;

Demineralised water.

450 ml of a 100 g/l (ZrO₂) ZrOCl₂ solution was mixed semi-continuously with 282 ml of an ammonium bicarbonate solution for one hour in a 1 litre reactor containing 268 ml of demineralised water. Under these conditions, the CO₃⁻/Zr mole ratio was 1. Stirring was carried out using a 4 paddle screw rotating at 500 min⁻¹. During the operation, the pH was controlled and maintained at a value of 4.8, using 12 mol/l ammonia. Once precipitation was complete, the pulp was filtered through a Büchner type filter to recover the solid formed. The synthesised hydroxycarbonate was washed with copious quantities of demineralised water. The cake was then oven dried for 12 h at 100° C., then calcined in a furnace at a temperature of 700° C. with a constant temperature stage of 4 h, then air cooled. Finally, the product underwent air jet grinding. A zirconium oxide was obtained with the characteristics shown in Table 1.

The 1 μm agglomerates could be disintegrated by wet grinding to aggregates with a size of 0.5 μm, determined by SEM.

### EXAMPLE 2

This example used the same steps as Example 1, with the exception that the calcining temperature was 1100° C. and only one air jet grinding step was carried out. The characteristics of the zirconium oxide formed under these conditions are shown in Table 1.

### EXAMPLE 3

This example used the same steps as Example 1, with the exception that the calcining temperature was 1050° C. and only one air jet grinding step was carried out. The characteristics of the zirconium oxide formed under these conditions are shown in Table 1.

TABLE 1

| Example | 1 | 2 | 3 |
|---|---|---|---|
| Cl content (ppm) | 71.0 | 100 | 80.0 |
| S content (ppm) | 4.60 | 3.10 | 4.70 |
| Ti content (ppm) | 1.8 | 1.7 | 1.1 |
| Na content (ppm) | 5.8 | 2.4 | 9.0 |
| Si content (ppm) | 270.0 | 170.0 | 230.0 |
| Specific surface area | 24 | 5 | 6 |
| (m²/g) | | | |
| d₅₀ (μm) | 1 | 0.45 | 0.25 |
| (Coulter laser) | (agglomerates) | (aggregates) | (aggregates) |
| Crystallite sizes (nm) | 30 | 60 | 64 |
| σ/m | 0.87 | 0.81 | 0.52 |
| Total pore volume | 0.97 | 0.43 | 0.52 |
| (cm³/g) | | | |

1. Zirconia, characterized in that it has a chlorine content of at most 300 ppm and a sulphur content of at most 30 ppm and in that it is in the form of a powder constituted either by agglomerates with an average size of at most 1.5 μm that can be disintegrated into aggregates with an average size in the range 0.1 μm to 0.6 μm, or by aggregates with an average size in the range 0.1 μm to 0.6 μm.

2. Zirconia according to claim 1, characterized in that it has a titanium content of at most 5 ppm.

3. Zirconia according to claim 1 or claim 2, characterized in that it has a sodium content of at most 10 ppm.

4. Zirconia according to any one of the preceding claims, characterized in that it has a silicon content of at most 300 ppm.

5. Zirconia according to any one of the preceding claims, characterized in that it has a chlorine content of at most 100 ppm, more particularly at most 80 ppm.

6. Zirconia according to any one of the preceding claims, characterized in that it has a sulphur content of at most 10 ppm, more particularly at most 5 ppm.

7. Zirconia according to any one of the preceding claims, characterized in that the aggregates are constituted by particles with an average size in the range 50 nm to 150 nm.

8. Zirconia according to any one of the preceding claims, characterized in that it has a specific surface area of at most 35 m²/g, more particularly at most 25 m²/g.

9. Zirconia according to claim 8, characterized in that it has a total pore volume of at most 1.5 ml/g and in that at least 40% of its porosity is supplied by pores with a diameter in the range 100 to 200 nm.

10. Zirconia according to any one of the preceding claims, characterized in that it is in the form of a pure monoclinic crystalline phase.

11. Zirconia according to any one of the preceding claims, characterized in that it comprises at least one stabilising element selected from calcium, magnesium, cerium, lanthanum, scandium and yttrium.

12. Zirconium hydroxycarbonate, characterized in that it has a chlorine content of at most 300 ppm and a sulphur content of at most 30 ppm, and in that following calcining, it is capable of producing a zirconia according to any one of the preceding claims.

13. A process for preparing a zirconia according to any one of claims 1 to 10, characterized in that it comprises the following steps:
reacting a zirconium oxychloride and an ammonium, alkali or alkaline-earth carbonate or bicarbonate, keeping the pH of the reaction medium constant;
separating the resulting precipitate;
calcining the precipitate.

14. A process for preparing a zirconia according to claim 11, characterized in that it comprises the following steps:
reacting a zirconium oxychloride containing a salt or an oxide of a stabilising element, and an ammonium, alkali or alkaline-earth carbonate or bicarbonate, keeping the pH of the reaction medium constant;
separating the resulting precipitate;
calcining the precipitate.

15. A process for preparing a zirconia according to claim 11, characterized in that it comprises the following steps:
reacting a zirconium oxychloride and an ammonium, alkali or alkaline-earth carbonate or bicarbonate, keeping the pH of the reaction medium constant, the reaction medium also containing a salt of a stabilising element;
separating the resulting precipitate;
calcining the precipitate.

16. A process for preparing a zirconia according to claim 12, characterized in that it comprises the following steps:
reacting a zirconium oxychloride and an ammonium, alkali or alkaline-earth carbonate or bicarbonate, keeping the pH of the reaction medium constant;
separating the resulting precipitate.

17. A process according to any one of claims 13 to 16, characterized in that the pH of the reaction medium is maintained at a value in the range 4 to 6.
